(19) United States
(12) Patent Application Publication
(10) Pub. No.: US 2001/0047475 A1
(43) Pub. Date: Nov. 29, 2001

(54) Data transfer system, communication device, radio device, dishonest copy preventive method, and record medium having recorded program

(75) Inventor: Hiroshi Terasaki, Tokyo (JP)

Correspondence Address: LAFF, WHITESEL & SARET, LTD., 401 North Michigan Avenue, Chicago, IL, 60611, US

(73) Assignee: NEC Corporation

(21) Appl. No.: 09/859,754

(22) Filed: May 17, 2001

(30) Foreign Application Priority Data
May 23, 2000 (JP) 2000-155959

(51) Int. Cl. H04L 9/00; G06F 13/42

(52) U.S. Cl. 713/160; 713/168; 710/126

(57) ABSTRACT

When data is transferred from an IEEE 1394 apparatus connected to an IEEE 1394 cable 6 to a USB apparatus 7 connected to a USB cable 8, by inserting within a packet of the USB a packet with the IEEE 1394 form transferred from the IEEE 1394 apparatus 5 and identification information for identifying the USB apparatus, which is defined on each USB apparatus 7, to transfer it to the USB, a difference in packet formats becomes possible to compensate, and DTCP, which is a dishonest copy preventive technology of the IEEE 1394, can be applied to the USB.

### BACKGROUND OF THE INVENTION

The present invention relates to a data transfer system that transfers copyright information among apparatuses connected to different buses, a communication device, a radio device, a dishonest copy preventive method, and a record medium having recorded a program, and more particularly to a data transfer system that caused DTCP (Digital Transmission Content Protection), which is a specification for a dishonest copy preventive technology of IEEE139, to be applicable in the other different buses, a communication device, a radio device, a dishonest copy preventive method, and a record medium having recorded a program.

Recently, attention has been paid to IEEE 1394 (IEEE Standard for a High Performance Serial Bus) and USB 1.1 (Universal Serial Bus Revision 1.1) as an interface for mutually connecting a personal computer (hereinafter, referred to as a PC) and a printer, a PC peripheral equipment such as a scanner, a digital video disk (hereinafter, referred to a DVD), a digital video camera, and so forth.

Many products of the IEEE 1394 and the USB 1.1 have been sold because of ease of a connection. Whereas the maximum transfer rate is 400 mega bits per second (Mbps) in the IEEE 1394, the maximum transfer rate is 12 mega bits per second (Mbps) in the USB 1.1, which is relatively low. Also, in the USB is allowable only a star-shaped topology in which a host (normally, the PC becomes a host) is centered, and the USB has been utilized as the interface for connecting low-rate PC peripheral equipment such as a telephone.

On the other hand, the IEEE 1394 is naturally applied to the low-rate apparatus as set forth above, but since it can be also utilized as the interface for an application in which bulk data such as dynamic image is processed, each has settled itself in its own application in the PC, namely the USB finds application in low-rate apparatus, and IEE1394 in high-rate apparatus. However, recently, a movement has surfaced for speeding up the USB 1.1 to newly specify USB 2.0 of which the maximum transfer rate is 40 times that of the current USB 1.1.

The USB 2.0 of which the maximum transfer rate is 480 mega bits per second (Mbps) nearly equalizes with the current IEEE 1394 of which the maximum transfer rate is 400 mega bits per second (Mbps) in the transfer rate. This allows data to be transferred in real time from an apparatus connected with the IEEE 1394 to an apparatus connected with the USB.

As with the conventional example that resembles the present invention in a technical field, see JP-A 145995/2000, DATA TRANSFER METHOD OF BUS.

In this conventional example has been offered a resource acquisition and a data transfer method in case that a plurality of buses that differ in a resource acquisition method were connected, and as shown in FIG. 15, upon an instruction by a user, after an initialization of the IEEE 1394, when a PC 50 tries to request an isochronous transfer to the USB apparatus, at first, it issues the request to an isochronous resource manager and then obtains it in a system in which the PC 50, a camera 51 and a television telephone 53 are connected as the USB apparatuses, a satellite broadcasting receiver (hereinafter, referred to as an IRD) 54 and a recorder (hereinafter, referred to as a DVCR) 55 are connected as the IEEE 1394 apparatuses, an adapter 52 is connected as an apparatus that acts as an intermediary among theses USB apparatuses and IEEE 1394 apparatuses, and the PC 50 plays a role for a host exchanging data in the USB. Next, it requests a pipe connection to the USB of the adapter 52, and initiates the isochronous transfer, if it succeeds. The adapter 52 receives data over the IEEE 1394 bus to transfer the received data to the PC 50, or the PC 50 receives image data from the camera 51 to send it to the adapter 52, and the adapter 52 then sends it to the IEEE 1394 side.

Nevertheless, no clear dishonest copy preventive technology has been specified in the USB, even though a specification of Digital Transmission Content Protection (hereinafter, referred to as DTCP) has been specified in the IEEE 1394 to prevent a dishonest copy.

The DTCP is the technology for receiving a key and an algorithm necessary for an authentication from a license management office to encrypt data flowing over IEEE 1394 serial bus, and to transmit and receive the encrypted data as shown in FIG. 16.

When a transmitter connected with the IEEE 1394 serial bus transmits data, it refers information of a copy control of the data (hereinafter, referred to as CCI: Copy Control Information), and depending upon the CCI, the authentication by a receiver is necessary. In the CCI, there are four ways of NO COPY, ONLY ONE COPY, NO MORE COPY and CLEAR TO COPY, and the other ways than the CLEAR TO COPY find application in the DTCP.

When a data receiver requests the data of the transmitter connected with the IEEE 1394 serial bus, it makes a request of the authentication to the transmitter. This request triggers off the authentication between the transmitter and the receiver. When the authentication succeeds, the receiver and the transmitter share a key, and the transmitter encrypts the data to transmit the encrypted data over the IEEE 1394 serial bus. The receiver decrypts the encrypted the data with the key shared at the authentication.

In case that such DTCP, which is the dishonest copy preventive technology, is applied to the USB, the following problems exist. At first, a packet format of the IEEE 1394 and the USB is different, and additionally, a packet header of the USB does not possess a function of a packet header essential for the DTCP (e.g. example, a bit indicating copy management information, a bit indicating a change timing of the key, and the like).

Also, the USB supports the data transfer between a host (normally, the PC) and a device, but the data transfer between fellow USB devices has not been defined. Accordingly, the DTCP in which a communication between fellow devices is necessary is not applicable as it is.

### SUMMARY OF THE INVENTION

Accordingly, the objective of the present invention is to solve the above-mentioned tasks.

Moreover, the objective of the present invention is to provide a data transfer system that enables compensation of a difference in packer formats, a communication device, a radio device, a dishonest copy preventive method, and a record medium having recorded a program, by defining copy management information that is at stake when the DTCP is applied to the other bus than the IEEE 1394 bus, and the data transfer between fellow devices.

A first invention that accomplishes the above-mentioned objective is a system of a data transfer between an IEEE 1394 apparatus that corresponded to the IEEE 1394, which was connected to the bus that corresponded to the IEEE 1394, and a communication device connected to the other bus than the bus that corresponded to said IEEE 1394, which is characterized by comprising packet form conversion means of: inserting within the packet with the form that corresponded to the other bus than the bus that corresponded to said IEEE 1394, the packet with the IEEE 1394 form transferred from the apparatus that corresponded to said IEEE 1394, and identification information for identifying the corresponding communication device, which was defined on each communication device, to transfer it to said communication device side; and fetching the packet with said IEEE 1394 form from the packet that corresponded to the other bus than the bus that corresponded to said IEEE 1394 into which were inserted the packet with said IEEE 1394 form and said identification information, which are generated by said communication device, to transfer it to the apparatus side that corresponded to said IEEE 1394.

A second invention that accomplishes the above-mentioned

objective is characterized in that in the above-mentioned first invention the other bus than the bus that corresponded to said IEEE 1394 is a serial bus.

A third invention that accomplishes the above-mentioned objective is characterized in that in the above-mentioned first invention the other bus than the bus that corresponded to said IEEE 1394 is anyone of a PCI bus, a PCMCIA bus, a SCSI bus, an ISA bus and a C bus.

A fourth invention that accomplishes the above-mentioned objective is a system of a data transfer between the apparatus that corresponded to the IEEE 1394, which was connected to the bus that corresponded to the IEEE 1394, and a radio device that communicates with radio, which is characterized by comprising packet form conversion means of: inserting within the packet with the form that corresponded to said radio device, the packet with the IEEE 1394 form transferred from the apparatus that corresponded to said IEEE 1394, and identification information for identifying said corresponding radio device, which was defined on each said radio device, to transfer it to said radio device side; and fetching the packet with said IEEE 1394 form from the packet with said IEEE 1394 form into which were inserted the packet with said IEEE 1394 form and said identification information, which are generated by said radio device, to transfer it to the apparatus side that corresponded to said IEEE 1394.

A fifth invention that accomplishes the above-mentioned objective is characterized in that in the above-mentioned fourth invention said communication with radio is a communication with a communication technology based on anyone of an IrDA and a Blue tooth.

A sixth invention that accomplishes the above-mentioned objective is a communication device connected to the other bus than the bus that corresponded to the IEEE 1394, which transmits/receives data to/from the apparatus that corresponded to the IEEE 1394, which was connected to the bus that corresponded to the IEEE 1394, which is characterized by including means of preparing a packet that includes: information of a copy control that set an allowable number of copy of the transfer data; information indicating the change timing of the cryptograph key that is used for encrypting the data to transmit and receive; and identification information for identifying said corresponding communication device, which was defined on each communication device connected to the other bus than the bus that corresponded to said IEEE 1394, to transfer the data to the apparatus that corresponded to said IEEE 1394.

A seventh invention that accomplishes the above-mentioned objective is characterized in that in the above-mentioned sixth invention the other bus than the bus that corresponded to said IEEE 1394 is a serial bus.

A eighth invention that accomplishes the above-mentioned objective is characterized in that in the above-mentioned sixth invention the other bus than the bus that corresponded to said IEEE 1394 is anyone of a PCI bus, a PCMCIA bus, a SCSI bus, an ISA bus and a C bus.

A ninth invention that accomplishes the above-mentioned objective is a communication device connected to the other bus than the bus that corresponded to the IEEE 1394, which transmits/receives data to/from the apparatus that corresponded to the specification of the IEEE 1394, which was connected to the bus that corresponded to the IEEE 1394, which is characterized by including means for preparing the packet in the packet form of the IEEE 1394, when the data is transferred to the apparatus that corresponded to said IEEE 1394.

A tenth invention that accomplishes the above-mentioned objective is characterized in that in the above-mentioned ninth invention the other bus than the bus that corresponded to said IEEE 1394 is a serial bus.

An eleventh invention that accomplishes the above-mentioned objective is characterized in that in the above-mentioned tenth invention the other bus than the bus that corresponded to said IEEE 1394 is anyone of a PCI bus, a PCMCIA bus, a SCSI bus, an ISA bus and a C bus.

A twelfth invention that accomplishes the above-mentioned objective is a radio device that transmits/receives data to/from the apparatus that corresponded to the specification of the IEEE 1394, which was connected to the bus that corresponded to the IEEE 1394, which is characterized by including means of preparing the packet that includes: information of a copy control that set an allowable number of copy of transfer data; information indicating the change timing of the cryptograph key that is used for encrypting the data to transmit and receive; and identification information for identifying said corresponding radio device, which was defined on each said radio device, to transfer the data to the apparatus that corresponded to said IEEE 1394.

A thirteenth invention that accomplishes the above-mentioned objective is characterized in that in the above-mentioned twelfth invention said communication with radio is a communication with a communication technology based on anyone of an IrDA and a Blue tooth.

A fourteenth invention that accomplishes the above-mentioned objective is a radio device that transmits/receives data to/from the apparatus that corresponded to the IEEE 1394, which was connected to the bus that corresponded to the IEEE 1394, which is characterized by including means for preparing the packet in the packet format of the IEEE 1394, when the data is transferred to the apparatus that corresponded to said IEEE 1394.

A fifteenth invention that accomplishes the above-mentioned objective is characterized in that in the above-mentioned fourteenth invention said communication with radio is a communication with a communication technology based on anyone of an IrDA and a Blue tooth.

A sixteenth invention that accomplishes the above-mentioned objective is a dishonest copy preventive method in a data transfer system that transfers data between the apparatus that corresponded to the IEEE 1394, which was connected to the bus that corresponded to the IEEE 1394, and a communication device connected to the other bus than the bus that corresponded to said IEEE 1394, which is characterized by comprising: a first packet form conversion step of inserting within the packet with the form that corresponded to the other bus than said IEEE 1394 bus, the packet with the IEEE 1394 form transferred from the apparatus that corresponded to said IEEE1394, and identification information for identifying the corresponding communication device, which was defined on each communication device, to transfer it to said communication device; and a second packet form conversion step of fetching the packet with said IEEE 1394 form from the packet with the other bus than the bus that corresponded to said IEEE 1394 into which were inserted the packet with said IEEE 1394 form and said identification information, which are generated by said communication device, to transfer it to said IEEE 1394 apparatus side.

A seventeenth invention that accomplishes the above-mentioned objective is characterized in that in the above-mentioned sixteenth invention the other bus than the bus that corresponded to said IEEE 1394 is a serial bus.

An eighteenth invention that accomplishes the above-mentioned objective is characterized in that in the above-mentioned sixteenth invention the other bus than the bus that corresponded to said IEEE 1394 is anyone of a PCI bus, a PCMCIA bus, a SCSI bus, an ISA bus and a C bus.

A nineteenth invention that accomplishes the above-mentioned objective is a dishonest copy preventive method in a data transfer system that transfers data between the apparatus that corresponded to the IEEE 1394, which was connected to the bus that corresponded to the IEEE 1394, and a radio device that communicates with radio, which is characterized by comprising: a first packet form conversion step of inserting within the packet with the form that corresponded to said radio communication, the packet with the IEEE 1394 form transferred from the apparatus that corresponded to said IEEE 1394, and identification information for identifying the corresponding radio device, which was defined on each said radio device, to transfer it to said radio device side; and

a second packet form conversion step of fetching the packet with said IEEE 1394 form from the packet with the format that corresponded to said radio communication into which were inserted the packet with said IEEE 1394 form and said identification information, which are generated by said radio device, to transfer it to the apparatus side that corresponded to said IEEE 1394.

A twentieth invention that accomplishes the above-mentioned objective is characterized in that in the above-mentioned nineteenth invention said communication with radio is a communication with a communication technology based on anyone of an IrDA and a Blue tooth.

A twenty-first invention that accomplishes the above-mentioned objective is a dishonest copy preventive method in a communication device connected to the other bus than the bus that corresponded to the IEEE 1394, which transmits/receives data to/from the IEEE 1394 apparatus connected to the bus that corresponded to the IEEE 1394, which is characterized by comprising the steps of: preparing the packet that includes information of a copy control that set an allowable number of copy of transfer data, information indicating the change timing of the cryptograph key that is used for encrypting the data to transmit and receive, and identification information for identifying said corresponding communication device, which was defined on each communication device connected to the other bus than the bus that corresponded to said IEEE 1394; and transferring said packet to the apparatus that corresponded to said IEEE 1394.

A twenty-second invention that accomplishes the above-mentioned objective is characterized in that in the above-mentioned twenty-first invention the other bus than said IEEE 1394 bus is a serial bus.

A twenty-third invention that accomplishes the above-mentioned objective is characterized in that in the above-mentioned twenty-first invention the other bus than said IEEE 1394 bus is anyone of a PCI bus, a PCMCIA bus, a SCSI bus, an ISA bus and a C bus.

A twenty-forth invention that accomplishes the above-mentioned objective is a dishonest copy preventive method in a communication device connected to the other bus than the bus that corresponded to the IEEE 1394, which transmits/receives data to/from the IEEE 1394 apparatus that corresponded to the IEEE 1394, which was connected to the bus that corresponded to the IEEE 1394, which is characterized by comprising a step of preparing the packet in the packet format of the IEEE 1394 when the data is transferred to the apparatus that corresponded to said IEEE 1394.

A twenty-fifth invention that accomplishes the above-mentioned objective is characterized in that in the above-mentioned twenty-fourth invention the other bus than said IEEE 1394 bus is a serial bus.

A twenty-sixth invention that accomplishes the above-mentioned objective is characterized in that in the above-mentioned twenty-fourth invention the other bus than said IEEE 1394 bus is anyone of a PCI bus, a PCMCIA bus, a SCSI bus, an ISA bus and a C bus.

A twenty-seventh invention that accomplishes the above-mentioned objective is a dishonest copy preventive method in a radio device that transmits/receives data with radio to/from the apparatus that corresponded to the IEEE 1394, which was connected to the bus that corresponded to the IEEE 1394, which is characterized by comprising the steps of: preparing the packet that includes, information of a copy control that set an allowable number of copy of transfer data, information indicating the change timing of the cryptograph key that is used for encrypting data to transmit and receive, and identification information for identifying said corresponding radio device, which was defined on each said radio device; and transferring said packet to the apparatus that corresponded to said IEEE 1394.

A twenty-eighth invention that accomplishes the above-mentioned objective is characterized in that in the above-mentioned twenty-seventh invention said communication with radio is a communication with a communication technology based on anyone of an IrDA and a Blue tooth.

A twenty-ninth invention that accomplishes the above-mentioned objective is a dishonest copy preventive method in a radio device that transmits/receives data with radio to/from the apparatus that corresponded to the IEEE 1394, which was connected to the bus that corresponded to the IEEE 1394, which is characterized by comprising a step of preparing the packet in the packet format of the IEEE 1394, when the data is transferred to the apparatus that corresponded to said IEEE 1394.

A thirtieth invention that accomplishes the above-mentioned objective is characterized in that in the above-mentioned twenty-ninth invention said communication with radio is a communication with a communication technology based on anyone of an IrDA and a Blue tooth.

A thirty-first invention that accomplishes the above-mentioned objective is a record medium having recorded a dishonest copy preventive program in a data transfer system that transfers data between the apparatus that corresponded to the IEEE 1394, which was connected to the bus that corresponded to the IEEE 1394, and a communication device connected to the other bus than the bus that corresponded to said IEEE 1394, which is characterized by having recorded a program for executing: a first packet form conversion process of inserting within the packet with the form that corresponded to the other bus than the bus that corresponded to said IEEE 1394, the packet with the IEEE 1394 form transferred from the apparatus that corresponded to said IEEE 1394, and identification information for identifying the corresponding communication device, which was defined on each communication device, to transfer it to said communication device side; and

a second packet form conversion process of fetching the packet with said IEEE 1394 form from the packet that corresponded to the other bus than the bus that corresponded to said IEEE 1394 into which were inserted the packet with said IEEE 1394 form and said identification information, which are generated by said communication device, to transfer it to the apparatus side that corresponded to said IEEE 1394.

A thirty-second invention that accomplishes the above-mentioned objective is characterized in that in the above-mentioned thirty-first invention the other bus than the bus that corresponded to said IEEE 1394 is a serial bus.

A thirty-third invention that accomplishes the above-mentioned objective is characterized in that in the above-mentioned thirty-first invention the other bus than the bus that corresponded to said IEEE 1394 is anyone of a PCI bus, a PCMCIA bus, a SCSI bus, an ISA bus and a C bus. A thirty-forth invention that accomplishes the above-mentioned objective is a record medium having recorded a dishonest copy preventive program in a data transfer system that transfers data between the apparatus that corresponded to the IEEE 1394, which was connected to the bus that corresponded to the IEEE 1394, and a radio device that communicates with radio, which is characterized by having recorded a program for executing: a first packet form conversion process of inserting within the packet with the form that corresponded to said radio communication, the packet with the IEEE 1394 form transferred from the apparatus that corresponded to said IEEE 1394, and identification information for identifying the corresponding communication device, which was defined on each said radio device, to transfer it to said radio device side; and a second packet form conversion process of fetching the packet with said IEEE 1394 form from the packet with the form that corresponded to said radio communication into which were inserted the packet with said IEEE 1394 form and said identification information, which are generated by said radio device, to transfer it to the apparatus side that corresponded to said IEEE 1394.

A thirty-fifth invention that accomplishes the above-mentioned objective is characterized in that in the above-mentioned thirty-fourth invention said communication with radio is a communication with a communication technology based on anyone of an IrDA and a Blue tooth.

A thirty-sixth invention that accomplishes the above-mentioned objective is a record medium having recorded a dishonest copy preventive program in a communication device connected to the other bus than the bus that corresponded to the IEEE 1394, which transmits/receives data to/from the apparatus that corresponded to the IEEE 1394, which was connected to the bus that corresponded to the IEEE 1394, which is characterized by having recorded a program for preparing the packet that includes: information of a copy control that set an allowable number of copy of transfer data; information indicating the change timing of the cryptograph key that is used for encrypting data to transmit and receive; and identification information for identifying the corresponding communication device, which was defined on each communication device connected to the other bus than the bus that corresponded to said IEEE 1394, to execute the data transfer to the apparatus that corresponded to said IEEE 1394.

A thirty-seventh invention that accomplishes the above-mentioned objective is characterized in that in the above-mentioned thirty-sixth invention the other bus than the bus that corresponded to said IEEE 1394 is a serial bus.

A thirty-eighth invention that accomplishes the above-mentioned objective is characterized in that in the above-mentioned thirty-sixth invention the other bus than the bus that corresponded to said IEEE 1394 is anyone of a PCI bus, a PCMCIA bus, a SCSI bus, an ISA bus and a C bus.

A thirty-ninth invention that accomplishes the above-mentioned objective is a record medium having recorded a dishonest copy preventive program in a communication device connected to the other than bus than the bus that corresponded to the IEEE 1394, which transmits/receives data to/from the apparatus that corresponded to the IEEE 1394, which was connected to the bus that corresponded to the IEEE 1394, which is characterized by having recorded a program for preparing the packet in the packet format of the IEEE 1394 to execute the data transfer to the apparatus that corresponded to said IEEE 1394, when the data is transferred to the apparatus that corresponded to said IEEE 1394.

A fortieth invention that accomplishes the above-mentioned objective is characterized in that in the above-mentioned thirty-ninth invention the other bus than the bus that corresponded to said IEEE 1394 is a serial bus.

A forty-first invention that accomplishes the above-mentioned objective is characterized in that in the above-mentioned thirty-ninth invention the other bus than the bus that corresponded to said IEEE 1394 is anyone of a PCI bus, a PCMCIA bus, a SCSI bus, an ISA bus and a C bus.

A forty-second invention that accomplishes the above-mentioned objective is a record medium having recorded a dishonest copy preventive program in a radio device that transmits/receives data with radio to/from the apparatus that corresponded to the IEEE 1394, which was connected to the bus that corresponded to the IEEE 1394, which is characterized by having recorded a program for preparing a packet that includes: information of a copy control that set an allowable number of copy of transfer data; information indicating the change timing of the cryptograph key that is used for encrypting the data to transmit and receive; and identification information for identifying the corresponding radio device, which was defined on each said radio device, to execute the data transfer to the apparatus that corresponded to said IEEE 1394.

A forty-third invention that accomplishes the above-mentioned objective is characterized in that in the above-mentioned forty-second invention said communication with radio is a communication with a communication technology based on anyone of an IrDA and a Blue tooth.

A forty-fourth invention that accomplishes the above-mentioned objective is a record medium having recorded a dishonest copy preventive program in a radio device that transmits/receives data with radio to/from the apparatus that corresponded to the IEEE 1394, which was connected to the bus that corresponded to the IEEE 1394, which is characterized by having recorded a program for preparing the packet in the packet format of the IEEE 1394 to execute the data transfer to the apparatus that corresponded to said IEEE 1394, when the data is transferred to the apparatus that corresponded to said IEEE 1394.

A forty-fifth invention that accomplishes the above-mentioned objective is characterized in that in the above-mentioned forty-fourth invention said communication with radio is a communication with a communication technology based on anyone of an IrDA and a Blue tooth.

### BRIEF DESCRIPTION OF THE DRAWING

This and other objects, features and advantages of the present invention will become more apparent upon a reading of the following detailed description and drawings, in which:

FIG. 1 is a block diagram illustrating an arrangement of a first embodiment relating to the present invention;

FIG. 2 is a block diagram illustrating an arrangement of a first embodiment relating to the present invention;

FIG. 3 is a diagram illustrating a packet format of an isochronous transfer for use in a data transfer with the IEEE 1394;

FIG. 4 is a diagram illustrating a packet format of an isochronous transfer that is used for an authentication with the IEEE 1394;

FIG. 5 is a diagram illustrating a packet format of the USB.

FIG. 6 is a diagram illustrating a packet format of the USB in the first embodiment.

FIG. 7 is a diagram illustrating a packet format of the USB in the second embodiment.

FIG. 8 is a block diagram illustrating an arrangement of a third embodiment relating to the present invention;

FIG. 9 is a block diagram illustrating an arrangement of a fifth embodiment relating to the present invention;

FIG. 10 is a block diagram illustrating an arrangement of a seventh embodiment relating to the present invention;

FIG. 11 is a block diagram illustrating an arrangement of a ninth embodiment relating to the present invention;

FIG. 12 is a block diagram illustrating an arrangement of an eleventh embodiment relating to the present invention;

FIG. 13 is a block diagram illustrating an arrangement of a thirteenth embodiment relating to the present invention;

FIG. 14 is a block diagram illustrating an arrangement of a fifteenth embodiment relating to the present invention;

FIG. 15 is a block diagram illustrating an arrangement of a conventional data transfer technology; and

FIG. 16 is a diagram for explaining an authentication for encrypting data to transmit the encrypted data between a transmitter and a receiver.

### DESCRIPTION OF THE EMBODIMENTS

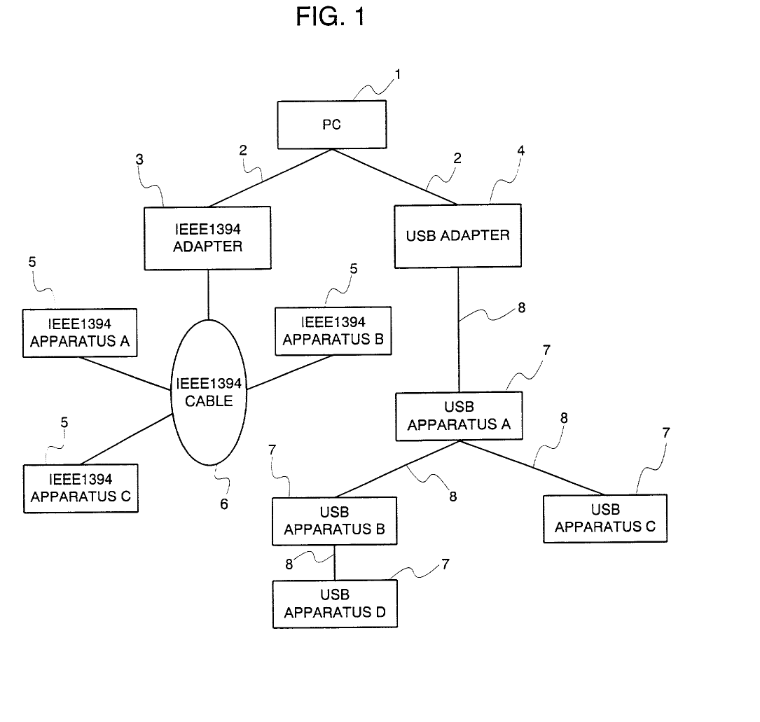

Next, an embodiment relating to a data transfer system of the present invention, a radio device, a dishonest copy preventive method thereof, and a record medium having recorded a dishonest copy preventive program thereof will be explained in details, referring to the accompanied drawings. Referring to FIG. 1 to FIG. 14, are shown the embodiments relating to the data transfer system of the present invention, the radio device, the dishonest copy preventive method thereof, and the record medium having recorded the dishonest copy preventive program thereof.

As shown in FIG. 1, in the embodiment relating to the present invention, to a personal computer (hereinafter, referred to as a PC) 1 are connected an IEEE 1394 adapter 3 and a USB adapter 4 via a PCI (Peripheral Component Interconnect)bus 2. The IEEE 1394 adapter 3 is connected to an IEEE 1394 cable 6 to which were connected an IEEE 1394 apparatus 5A, an IEEE 1394 apparatus 5B and an IEEE 1394 apparatus 5C respectively. Also, to the USB adapter 4 are connected a USB apparatus 7A, a USB apparatus 7B, a USB apparatus 7C and a USB apparatus 7D in a tree shape by a USB cable 8.

The PC 1 is an apparatuss equipped with an interface with the IEEE 1394 and the USB, and the PC 1 plays a role of a host in the USB.

The IEEE 1394 apparatus 5A, the IEEE 1394 apparatus 5B and the IEEE 1394 apparatus 5C are apparatuses provided with only the interface of the IEEE 1394 (namely, IEEE 1394 apparatuses), and the USB apparatus 7A, the USB apparatus 7B and the USB apparatus 7C are apparatuses provided with only the interface of the USB (namely, USB apparatuses). In addition, with regard to the IEEE 1394 apparatus 5 and the USB apparatus 7, the case is acceptable in which the IEEE 1394 apparatus is provided with the interface of the USB and the USB apparatus is equipment with the interface of the IEEE 1394.

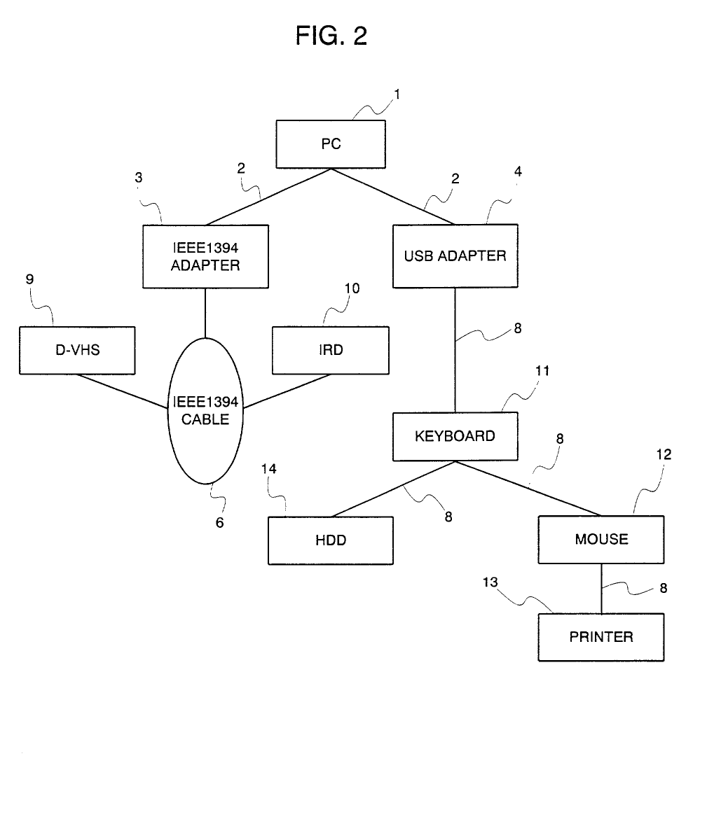

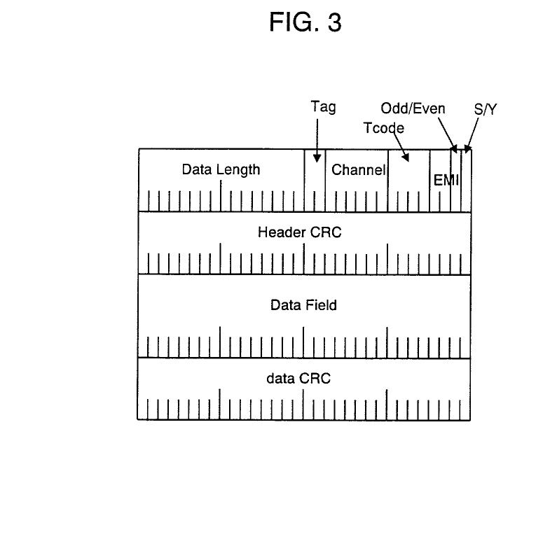

In FIG. 2, is shown an arrangement of the case in which specific equipments were applied to the IEEE 1394 apparatus 5 and the USB apparatus 7 shown in FIG. l. As shown in the same FIG. , a digital VHS (hereinafter, referred to as a D-VHS) 9 and a digital satellite-broadcasting receiver (hereinafter, referred to as an IRD: Integrated Receiver Decoder) 10 are connected as the IEEE 1394 apparatuses, and a key board 11, a mouse 12, a printer 13 and a hard disk drive (hereinafter, referred to as a HDD: Hard DISK Drive) 14 are connected as the USB apparatuses. Also, in FIG. 3, is shown a packet format of the isochronous transfer for use in the data transfer in the IEEE 1394. As shown in the same FIG. , in the packet format of the isochronous transfer are provided each field of a Data Length, a Tag, a channel, a T code, an EMI, an Odd/Even, a SY, a Header_CRC, a Data Field, and a Data_CRC.

The Data length is a field for specifying a byte length of a data field following a header.

The Tag is a field illustrating a format of the isochronous packet.

The channel is a field illustrating a channel number for use in the identification of the isochronous packet.

The Tcode (Transaction code) is a field illustrating a code indicating a classification of the packet.

The EMI (Encryption Mode Indicator) is a field illustrating contents of the CCI.

The Odd/Even is a field illustrating a change timing of a cryptograph key.

The SY (Synchronization code) is a field for use in exchange of synchronous information such as video, voice and the like between a transmitting node and a receiving node.

The Header_CRC is a field illustrating a CRC (Cyclic Redundancy Check) for header information.

The Data is a field into which payload data is inserted.

The Data_CRC is a field to which the CRC is added for the data payload.

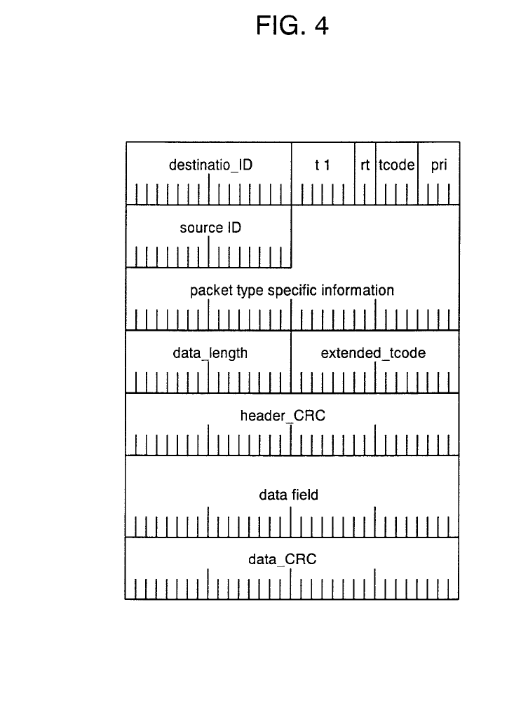

Also, in FIG. 4 is shown a packet format of the asynchronous (a write request) transfer that is used for the authentication. As shown in the same FIG. , in the packet format of the asynchronous transfer are provided fields of a destination_ID, a tl, a rt, a tcode, a pri, a source_ID, a packet type specific information, a data_length, an extended_tcode, a header_CRC, a data field, and a data_CRC.

The destination_ID (Destination IDentifier) is a field indicating an ID of a node of a transmitting destination.

The tl (Transaction label) is a field indicating a label for acknowledging a match between a pair of transactions of a request packet and a response packet.

The rt (Retry code) is a field indicating information associated with a retry method at the time when an acknowledge packet of being busy is received.

The tcode (Transaction code) is a field indicating a classification code of a transaction packet.

The pri (Priority) is entirely 0 (zero) in a fair arbitration (an arbitration for guaranteeing a fair bus access for all transmision request nodes over the bus).

The source_ID is a field indicating ID information of a node of a packet transmitting end.

The packet type specific information is a field indicating information peculiar to each packet type, wherein are inserted a destination_offset(indicating an object address over register space of a node of a packet transmitting destination), a rcode (Response code) and a reserved (Reservation field), and so forth.

In case that the data payload is present in the packet, the data_length indicates a length (byte) thereof.

The extended_tcode, which has meaning only when the packet is a packet with a lock, indicates a classification of the lock.

In the IEEE 1394, the maximum transfer size of the asynchronous transfer has been determined on each transfer rate, which is adapted to be 512 bytes at S100 (98.304 Mbps), 1024 bytes at S200 (196.608 Mbps), and 2048 bytes at S400 (393.216 Mbps) respectively.

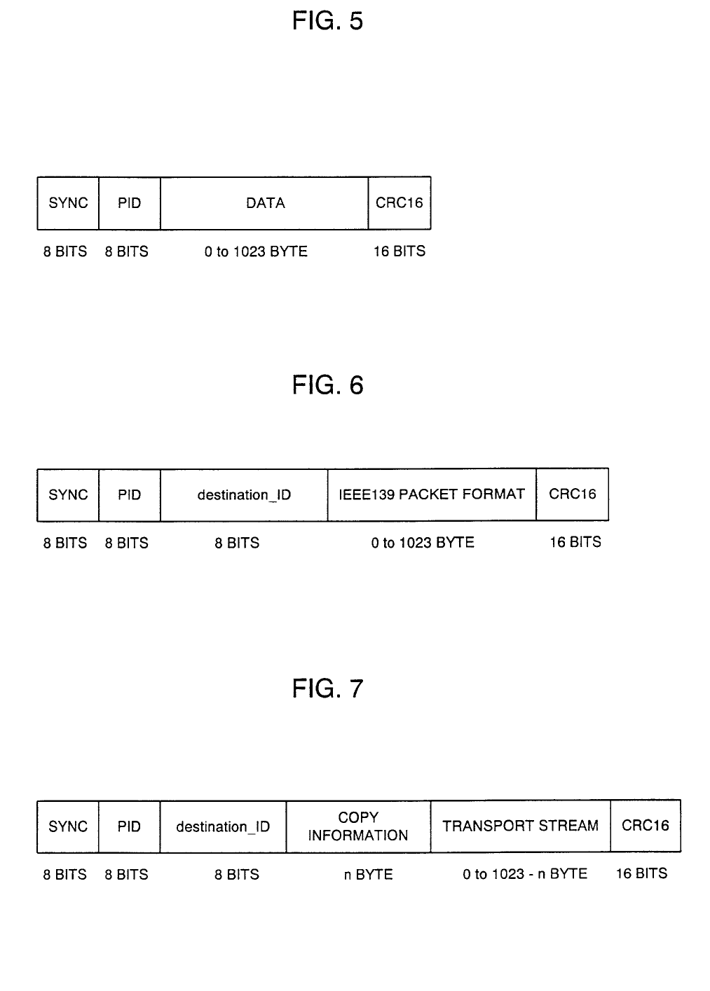

Also, in FIG. 5, is shown a packet format of the isochronous transfer for use in the data transfer of the USB, and of a bulk transfer for use in the authentication (Refer to the Universal Serial Bus Specification Revision 1.1). As shown in the same FIG. , the packet of the isochronous transfer and of the bulk transfer consists of fields of a SYNC (Synchronous Idle), a PID (Packet ID), a DATA, a CRC (Cyclic Redundancy Check Code) 16. In addition, this data packet has been defined so that data up to 1024 bytes can be transferred.

The present embodiment, which consists of the above-mentioned arrangement, is characterized in that the DTCP, which is used in the IEEE 1394, is also applied in the USB cable so that copyright information can be transmitted and received between fellow apparatuses connected to the different buses, i.e. IEEE 1394 cable and the USB cable.

A protocol function essential for the DTCP set forth above is to possess a packet header indicating copy management information and to be defined so that fellow devices can communicate.

As apparent from FIG. 3, 4, and 5, the IEEE 1394 and the USB differ in a packet format. In order to apply the DTCP to the USB, at first, it is necessary to add 2 bits indicating the CCI and one (1) bit indicating a change timing of a key at the time when data is transferred.

Therefore, in the present embodiment, when data is transferred from the IEEE 1394 apparatus to the USB apparatus, at the PC 1 that is positioned between the IEEE 1394 adapter 3 and the USB adapter 4, the packet format of the IEEE 1394 is applied to a data region of the data packet of the USB as shown in FIG. 6. Namely, the PC 1 plays a role of a format conversion adapter of the IEEE 1394 and the USB.

When the data is transferred from the IEEE 1394 apparatus to the USB apparatus, the packet of the IEEE 1394 shown in FIG. 3 enters the data region of the packet format of the USB as shown in FIG. 6. This allows the bit indicating the CCI and the bit indicating the change timing of the key to materialize in the data packet of the USB as well. In addition, also at the time of the authentication the packet of the IEEE 1394 shown in FIG. 4 enters it.

Also, in the data transfer from the USB apparatus to the IEEE 1394 apparatus, in order to add the 2 bits indicating the CCI and the bit indicating the change timing of the key, each USB apparatus generates the USB packet (FIG. 6) in which the packer format of the IEEE 1394 shown in FIG. 3 was applied to the data region of the packet. Also, the PC 1, which plays a role of the packet form conversion adapter between the IEEE 1394 and the USB, fetches the packet of the IEEE 1394 format from the data region of the USB packet shown in FIG. 6 and transfers it to the IEEE 1394 apparatus side.

Also, in the USB, a communication between the fellow hosts and between fellow devices has not been defined. For this reason, the DTCP that needs a communication between the devices can not been applied in the USB packet.

Therefore, in order to apply the DTCP, as shown in FIG. 6, an identifier (referred to as a Destination ID) of the USB device is newly defined to realize the communication between the devices.

This is, for example, an 8-bit identifier in which one value was assigned to one device within the USB bus, which a host is to assign to each device at the time of initializing the bus. The use of this identifier enables the communication between the fellow devices.

In the embodiment shown in FIG. 2, the PC 1 (host) assigns at the time of initializing the bus the identifiers to each device such as that the keyboard is [1], the mouse [2], the HDD is [3] and the printer is [4]. This allows the data to be directly sent from the HDD [3] to the printer [4]. Also, each device keeps the identifier assigned by the host in a device descriptor. In addition, the device descriptor, which is for describing general information of the USB device, is configured to include the defined data.

Thus, in the data transfer from the IEEE 1393 apparatus to the USB apparatus, in the PC 1 the USB packet is generated in which the data of the IEEE 1394 format transferred from the IEEE 1393 apparatus was applied to the data region of the USB, and transferred to the USB side, and also in the time when the data is transferred from the USB apparatus to the IEEE 1393 apparatus, each USB apparatus generates the USB packet in which the data region of the packet was generated in the packet format of the IEEE 1394. Also, at the time of initialization of the bus, by the PC 1 assigning the identifier to each USB, the DTCP becomes possible to apply between the apparatus connected to the IEEE 1394 bus and the apparatus connected to the USB bus. Accordingly, a dishonest copy of information being transmitted and received between the IEEE 1394 apparatus and the USB apparatus can be prevented.

Also, in order to transmit and receive copyright information between the IEEE 1394 apparatus connected to the IEEE 1394 bus and the USB apparatus connected to the USB bus, the existing DTCP specified by the IEEE 1394 was caused to be applicable in the USB side, thereby an application of the dishonest copy preventive technology that differs bus by bus can be dispensed with, and an expenditure of a system architecture for transmitting and receiving copyright information can be reduced.

Next, an operation of the case will be explained in which the DTCP was applied between the IEEE 1394 apparatus and the USB apparatus, referring to FIG. 2.

In an arrangement shown in FIG. 2, the case will be explained in which data is copied from the IRD 10 connected to the IEEE 1394 bus to the HDD 14 connected to the USB bus.

The HHD 14 requests a data transmission of the IRD 10 via the USB adapter 4 and the IEEE 1394 adapter 3.

The PC 1 which includes: a [function of developing a connection] for conducting a connection of a signal path between the IEEE 1394 apparatus and the USB apparatus; a [function of maintaining a connection] for maintaining the connected signal path; and a function of the packet form conversion from the IEEE 1394 to the USB, and of the packet form conversion from the USB to the IEEE 1394, which is reverse hereto, always supervises an exchange of the data between the IEEE 1394 apparatus and the USB apparatus.

The IRD 10 checks the CCI of the data requested by the HDD 14 and transmits it to the HDD as it is, if it is data that is not a copyright protection object.

Also, in case that the data requested by the HDD 14 is data of the copyright protection object, the IRD 10 waits for the authentication request from the HDD 14. And, upon receiving the authentication request from the HDD 14, the IRD 10 obtains a key in common between the HDD 14 and the IRD 10.

The IRD 10 encrypts the data by use of the key shared with the HDD 14, and transmits the encrypted data to the HDD 14 through the IEEE 1394 adapter 3, the PC 1, and the USB adapter 4. In this moment, in the PC 1, when the data of the IEEE 1394 format is converted into the data of the USB format, the packet format of the IEEE 1394 is applied to the data section of the data packet of the USB. Accordingly, also in the data packet of the USB can materialize the bit indicating the CCI and the bit indicating the change timing of the key, and the copyright information is becomes possible to transmit and receive between the different buses.

Also, when the copyright protection object information is transferred from the USB apparatus to the IEEE 1394 apparatus, the PC 1 fetches the data that was generated in the IEEE 1394 packet format in the USB apparatus and that was inserted into the data region of the USB, and transfers the fetched data to the IEEE 1394 side.

The operation set forth above allows the copyright protection object information to be transmitted and received between the IEEE 1394 apparatus and the USB apparatus.

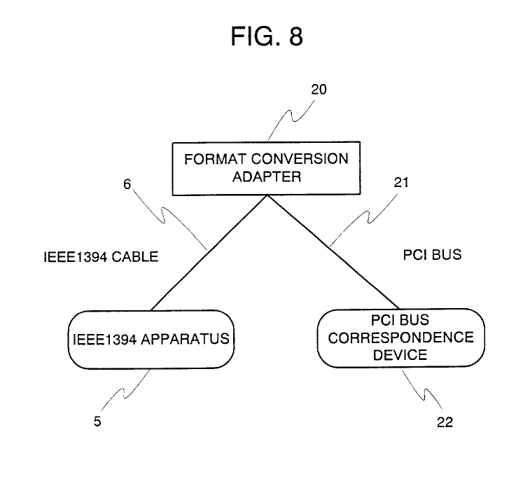

Next, the second embodiment relating to the present invention will be explained, referring to FIG. 8.

The second embodiment relating to the present invention is characterized by newly defining for the packet of the USB the dishonest copy protection bit indicating the CCI and the change timing of the key, and the [Destination ID] as shown in FIG. 7. Accordingly, the dishonest copy protection technology of the IEEE 1394 becomes possible to apply in the packet format of the USB as well. Also, like the first embodiment set forth above, when the data is transferred from the IEEE 1394 apparatus to the USB apparatus, in the PC 1 that becomes a host of the USB, a conversion for incorporating the data of the IEEE 1394 format transferred from the IEE1394 apparatus into the data region of the USB packet is obviated. In addition, in the embodiment shown in FIG. 7, the dishonest copy protection bit indicating the CCI and the change timing of the key is defined as 8 bits, but this bit number is not limited to eight (8), which is practicable suitably.

Next, the third embodiment relating to the present invention will be explained, referring to FIG. 8. The third embodiment relating to the present invention is characterized by applying the DTCP technology of the IEEE 1394 to a PCI bus to mutually transmit and receive the copyright information between the IEEE 1394 apparatus connected to the IEEE 1394 bus and the device connected to the PCI bus by use of the DTCP technology.

In order to accomplish this objective, when the copyright information is transferred from the IEEE 1394 apparatus 5 connected to the IEEE 1394 cable 6 to a device 22 connected to a PCI bus 21 as shown in FIG. 8, in a format conversion adapter 20 between the IEEE 1394 apparatus 5 and the PCI bus correspondence device 22, the IEEE 1394 packet transferred from the IEEE 1394 apparatus 5 is inserted into the data section of the data packet that is possible to transfer with the PCI bus. Also, the format conversion adapter 20 inserts into this data packet the [Destination ID] that is the identifier of the device over the PCI bus.

Also, when the data is transferred from the device 22 connected to the PCI bus to the IEEE 1394 apparatus 5 connected to the IEEE 1394 bus, in the device 22 connected to the PCI bus 21, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 20, wherein the data generated in the IEEE 1393 format is fetched from the data region of the data packet, and transferred to the IEEE 1394 apparatus side.

In such a manner, the DTCP becomes possible to apply between the IEEE 1394 apparatus connected to the IEEE 1394 bus and the device connected to the PCI bus, and the dishonest copy of information being transmitted and received between the IEEE 1394 apparatus and the PCI bus correspondence device can be prevented.

Also, in order to transmit and receive the copyright information between the IEEE 1394 apparatus connected to the IEEE 1394 bus and the device connected to the PCI bus, the existing DTCP specified by the IEEE 1394 was caused to be applicable in the PCI side as well, thereby, an application of the dishonest copy preventive technology that differs bus by bus can be dispensed with, and an expenditure of a system architecture for transmitting and receiving the copyright information can be reduced.

Next, the forth embodiment relating to the present invention will be explained. The fourth embodiment relating to the present invention is characterized by newly defining for the packet of the PCI the dishonest copy protection bit indicating the CCI and the change timing of the key, and the [Destination ID]. This allows the dishonest copy protection technology of the IEEE 1394 to be applied to the packet format of the PCI as well.

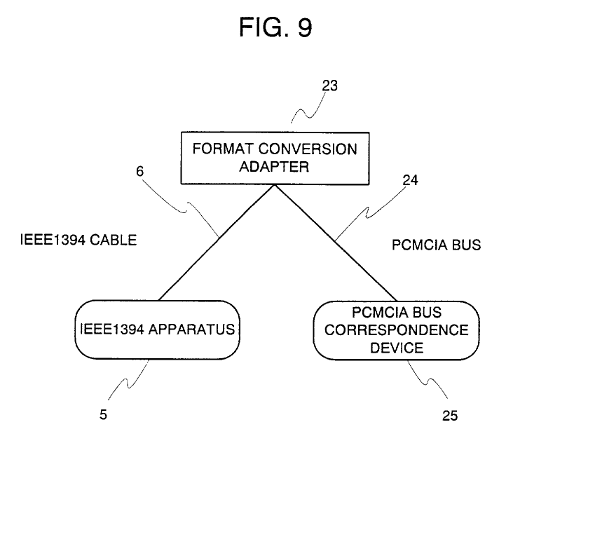

Next, the fifth embodiment relating to the present invention will be explained, referring to FIG. 9. The fifth embodiment relating to the present invention is characterized by applying the DTCP technology of the IEEE 1394 to a PCMCIA bus to mutually transmit and receive the copyright information between the IEEE 1394 apparatus connected to the IEEE 1394 bus and the device connected to the PCMCIA bus by use of the DTCP technology.

In order to accomplish this objective, when the copyright information is transferred from the IEEE 1394 apparatus 5 connected to the IEEE 1394 cable 6 to a device 25 connected to a PCMCIA bus 24 as shown in FIG. 9, in a format conversion adapter 23 between the IEEE 1394 apparatus 5 and the PCMCIA bus correspondence device 25, the IEEE 1394 packet transferred from the IEEE 1394 apparatus 5 is inserted into the data section of the data packet that is possible to transfer with the PCMCIA bus.

Also, the format conversion adapter 23 inserts into this data packet the [Destination ID] that is the identifier of the device over the PCMCIA bus 24.

Also, when the data is transferred from the device 25 connected to the PCMCIA bus 24 to the IEEE 1394 apparatus 5 connected to the IEEE 1394 cable 6, in the device 25 connected to the PCMCIA bus 24, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 23, wherein the data generated in the IEEE 1394 format is fetched from the data region of the data packet and transferred to the IEEE 1394 apparatus 5 side.

In such a manner, the DTCP is possible to apply between the IEEE 1394 apparatus connected to the IEEE 1394 bus and the device connected to the PCMCIA bus, and the dishonest copy of information being received and transmitted between the IEEE 1394 apparatus and the PCMCIA bus correspondence device can be prevented.

Also, in order to transmit and receive the copyright information between the IEEE 1394 apparatus connected to the IEEE 1394 bus and the device connected to the PCMCIA bus, the existing DTCP specified by the IEEE 1394 was caused to be applicable in the PCMCIA side as well, thereby, an application of the dishonest copy preventive technology that differs bus by bus can be dispensed with, and an expenditure of a system architecture for transmitting and receiving the copyright information can be reduced.

Next, the sixth embodiment relating to the present invention will be explained. The sixth embodiment relating to the present invention is characterized by newly defining for the packet of the PCMCI the dishonest copy protection bit indicating the CCI and the change timing of the key, and [Destination ID]┘ defined in the embodiments set forth above. This allows the dishonest copy protection technology of the IEEE 1394 to be applied to the packet format of the PCMCIA as well.

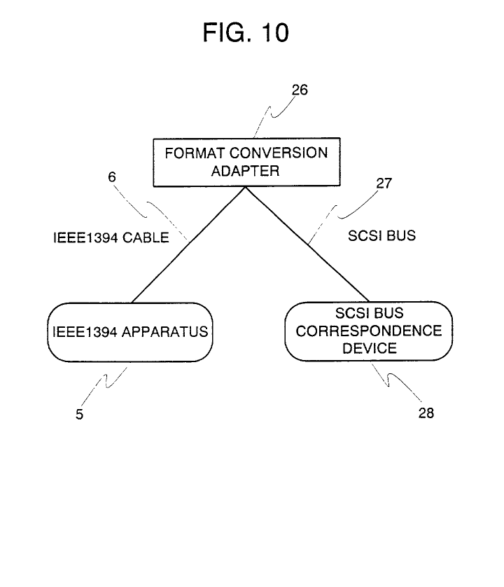

Next, the seventh embodiment relating to the present invention will be explained, referring to FIG. 10. The seventh embodiment relating to the present invention is characterized by applying the DTCP technology of the IEEE 1394 to a SCSI bus to mutually transmit and receive the copyright information between the IEEE 1394 apparatus connected to the IEEE 1394 bus and the device connected to the SCSI bus by use of the DTCP technology.

In order to accomplish this objective, when the copyright information is transferred from the IEEE 1394 apparatus 5 connected to the IEEE 1394 cable 6 to a device 28 connected to a SCSI bus 27 as shown in FIG. 10, in a format conversion adapter 26 between the IEEE 1394 apparatus 5 and the SCSI bus correspondence device 28, the IEEE 1394 transferred from the IEEE 1394 apparatus is inserted into the data section of the data packet that is possible to transfer with the SCSI bus 27. Also, the format conversion adapter 26 inserts into this data packet the [Destination ID] that is the identifier of the device over the SCSI bus.

Also, when the data is transferred from the device 28 connected to the SCSI bus to the IEEE 1394 apparatus 5 connected to the IEEE 1394 cable 6, in the device 28 connected to the SCSI bus 27, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 26, wherein the data generated in the IEEE 1394 format is fetched from the data region of the data packet and transferred to the IEEE 1394 apparatus 5 side.

In such a manner, the DTCP becomes possible to apply between the IEEE 1394 apparatus connected to the IEEE 1394 bus and the device connected to the SCSI bus, and the dishonest copy of information being transmitted and received between the IEEE 1394 apparatus and the device connected to the SCSI bus can be prevented.

Also, in order to transmit and receive the copyright information between the IEEE 1394 apparatus connected to the IEEE 1394 bus and the device connected to the SCSI bus, the existing DTCP specified by the IEEE 1394 was caused to be applicable in the SCSI side as well, thereby, an application of the dishonest copy preventive technology that differs bus by bus can be dispensed with, and an expenditure of a system architecture for transmitting and receiving the copyright information can be reduced.

Next, the eighth embodiment relating to the present invention will be explained. The eighth embodiment relating to with the present invention is characterized by newly defining for the packet of the SCSI the dishonest copy protection bit indicating the CCI and the change timing of the key, and the [Destination ID] defined in the foregoing embodiments. This allows the dishonest copy protection technology of the IEEE 1394 to be applied to the packet format of the SCSI as well.

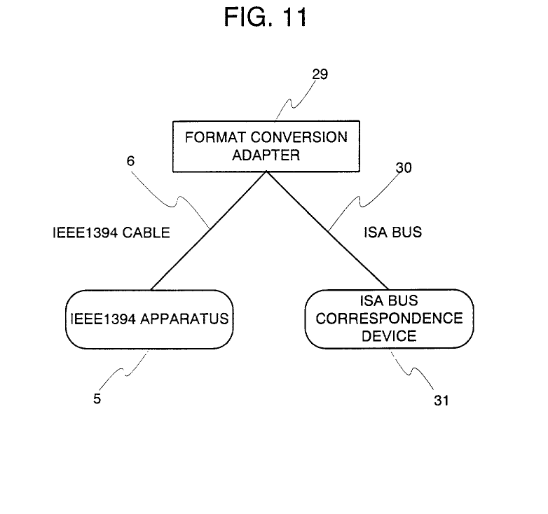

Next, the ninth embodiment relating to the present invention will be explained, referring to FIG. 11. The ninth embodiment relating to the present invention is characterized by applying the DTCP technology of the IEEE 1394 to an ISA bus to mutually transmit and receive the copyright information between the IEEE 1394 apparatus connected to the IEEE 1394 bus and the device connected to the ISA bus by use of the DTCP technology.

In order to accomplish this objective, when the copyright information is transferred from the IEEE 1394 apparatus 5 connected to the IEEE 1394 cable 6 to a device 31 connected to an ISA bus 30 as shown in FIG. 11, in a format conversion adapter 29 between the IEEE 1394 apparatus 5 and the ISA bus correspondence device 31, the IEEE packet transferred from the IEEE 1394 apparatus 5 is inserted into the data section of the data packet that is possible to transfer with the ISA bus 30. Also, the format conversion adapter 29 inserts into this data packet the [Destination ID] that is the identifier of the device over the ISA bus 30.

Also, when the data is transferred from the device 31 connected to the ISA bus 30 to the IEEE 1394 apparatus 5 connected to the IEEE 1394 cable 6, in the device 31 connected to the ISA bus 30, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 29, wherein the data generated in the IEEE 1394 format is fetched from the data region of the data packet and transferred to the IEEE 1394 apparatus 5 side.

In such a manner, the DTCP is possible to apply between the IEEE 1394 apparatus connected to the IEEE 1394 bus and the device connected to the ISA bus, and the dishonest copy of information being transmitted and received between the IEEE 1394 apparatus and the ISA apparatus can be prevented.

Also, in order to transmit and receive the copyright information between the IEEE 1394 apparatus connected to the IEEE 1394 bus and the device connected to the ISA bus, the existing DTCP specified by the IEEE 1394 was caused to be applicable in the ISA side as well, thereby, an application of the dishonest copy preventive technology that differs bus by bus can be dispensed with, and an expenditure of a system architecture for transmitting and receiving the copyright information can be reduced.

Next, the tenth embodiment relating to the present invention will be explained. The tenth embodiment relating to the present invention is characterized by newly defining for the data packet of the ISA the dishonest copy protection bit indicating the CCI and the change timing of the key, and the [Destination ID] defined in the embodiments set forth above. This allows the dishonest copy protection technology of the IEEE 1394 to be applied to the packet format of the ISA as well.

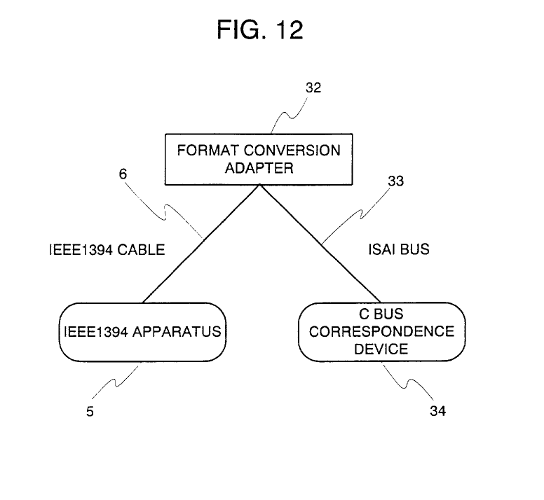

Next, the eleventh embodiment relating to the present invention will be explained, referring to FIG. 12. The eleven embodiment relating to the present invention is characterized by applying the DTCP technology of the IEEE 1394 to a C bus to mutually transmit and receive the copyright information between the IEEE 1394 device connected to the IEEE 1394 and the device connected to the C bus by use of the DTCP technology.

In order to accomplish this objective, when the copyright information is transferred from the IEEE 1394 apparatus 5 connected to the IEEE 1394 cable 6 to a device 34 connected to the C bus 33 as shown in FIG. 12, in a format conversion adapter 32 between the IEEE 1394 apparatus 5 and the C bus correspondence device 34, the IEEE 1394 packet transferred from the IEEE 1394 apparatus 5 is inserted into the data section of the data packet that is possible to transfer with the C bus. Also, the format conversion adapter 32 inserts into this data packet the [Destination ID] that is the identifier of the device over the C bus 33.

Also, when the data is transferred from the device 34 connected to the C bus 33 to the IEEE 1394 apparatus 5 connected to the IEEE 1394 cable 6, in the device 34 connected to the C bus 33, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 32, wherein the data generated in the IEEE 1394 format is fetched from the data region of the data packet and transferred to the IEEE 1394 apparatus 5 side.

In such a manner, the DTCP becomes possible to apply between the IEEE 1394 apparatus connected to the IEEE 1394 bus and the device connected to the C bus, and the dishonest copy of information being transmitted and received between the IEEE 1394 apparatus and the C bus correspondence apparatus can be prevented.

Also, in order to transmit and receive the copyright information between the IEEE 1394 apparatus connected to the IEEE 1394 bus and the device connected to the C bus, the existing DTCP specified by the IEEE 1394 was caused to be applicable in the C side as well, thereby, an application of the dishonest copy preventive technology that differs bus by bus can be dispensed with, and an expenditure of a system architecture for transmitting and receiving the copyright information can be reduced.

Next, the twelfth embodiment relating to the present invention will be explained. The twelfth embodiment relating to the present invention is characterized by newly defining for the packet in the C bus the dishonest copy protection bit indicating the CCI and the change timing of the key, and the [Destination ID] defined in the embodiments set forth above. This allows the dishonest copy protection technology of the IEEE 1394 to be applied to the packet format of the C bus as well.

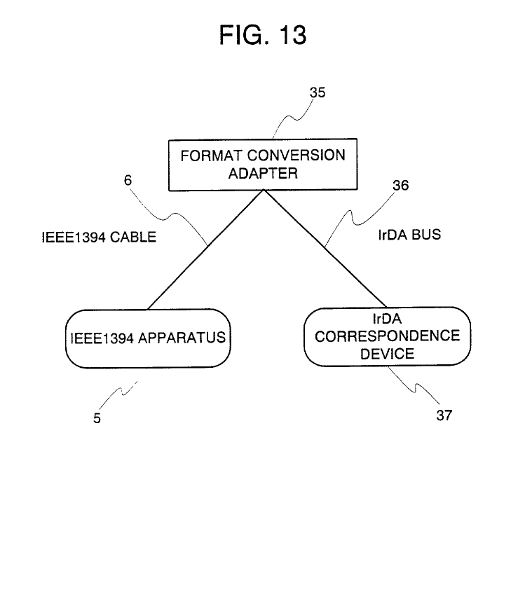

Next, the thirteenth embodiment relating to the present invention will be explained, referring to FIG. 13. The thirteenth embodiment relating to the present invention is characterized by applying the DTCP technology of the IEEE 1394 to IrDA (Infrared Data Association) to mutually transmit and receive the copyright information by use of the DTCP technology between the IEEE 1394 apparatus connected to the IEEE 1394 bus and the device that communicates with the IrDA.

In order to accomplish this objective, when the copyright information is transferred from the IEEE 1394 apparatus 5 connected to the IEEE 1394 cable 6 to a device 37 that communicates with the IrDA as shown in FIG. 13, in a format conversion adapter 35, the IEEE 1394 packet transferred from the IEEE 1394 apparatus 5 is inserted into the data section of the data packet that is possible to transfer with the IrDA. Also, the format conversion adapter 35 inserts into this data packet the [Destination ID] that is the identifier of the device.

Also, when the data is transferred from the device 37 that communicates with IrDA to the IEEE 1394 apparatus 5 connected to the IEEE 1394 cable 6, in the IrDA correspondence device 37, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 35, wherein the data generated in the IEEE 1394 format is fetched from the data region of the data packet and is transferred to the IEEE 1394 apparatus side.

In such a manner, the DTCP becomes possible to apply between the IEEE 1394 apparatus connected to the IEEE 1394 bus and the device that communicates with the IrDA, and the dishonest copy of information being transmitted and received between the IEEE 1394 apparatus and the IrDA correspondence communication device can be prevented.

Also, in order to transmit and receive the copyright information between the IEEE 1394 apparatus connected to the IEEE 1394 bus and the IrDA correspondence device, the existing DTCP specified by the IEEE 1394 was caused to be applicable in the IrDA side as well, thereby, an application of the dishonest copy preventive technology that differs bus by bus can be dispensed with, and an expenditure of a system architecture for transmitting and receiving the copyright information can be reduced.

Next, the fourteenth embodiment relating to the present invention will be explained. The fourteenth embodiment relating to the present invention is characterized by newly defining for the packet of the IrDA the dishonest copy protection bit indicating the CCI and the change timing of the key, and the [Destination ID] defined in the embodiments set forth above . This allows the dishonest copy protection technology of the IEEE 1394 to be applied to the data packet of the IrDA as well.

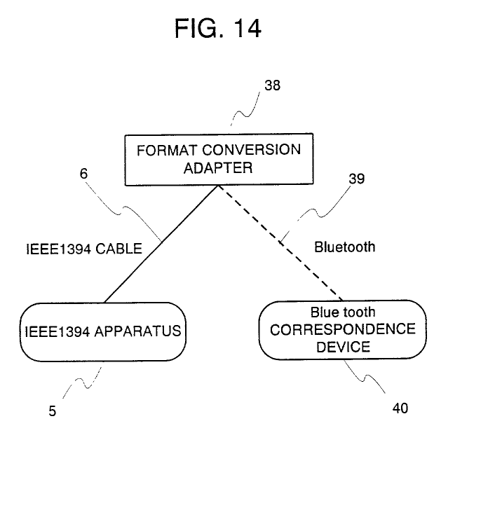

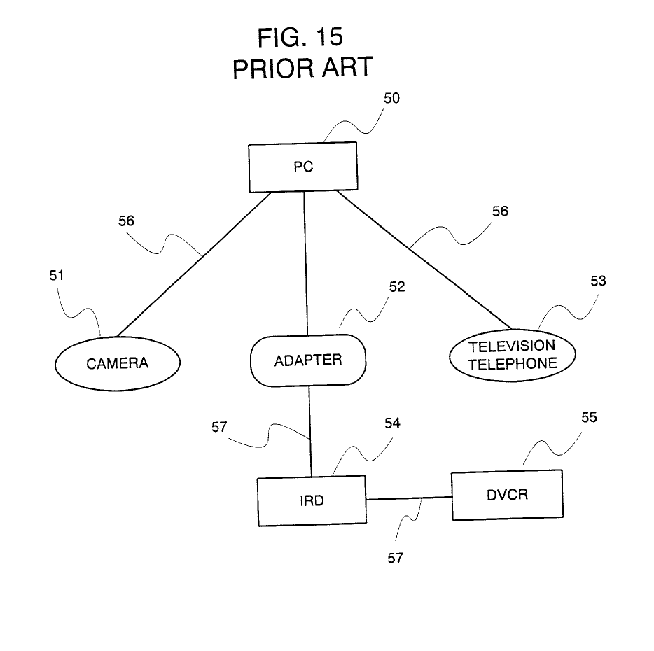

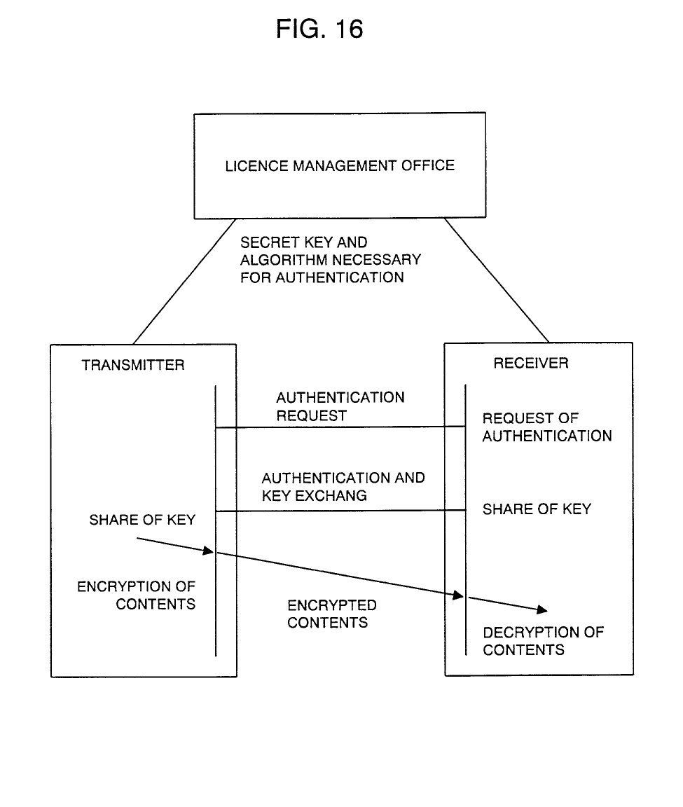

Next, the fifteenth embodiment relating to the present invention will be explained, referring to FIG. 14. The fifteenth embodiment relating to the present invention is characterized by applying the DTCP technology of the IEEE 1394 to Blue tooth to mutually transmit and receive the copyright information by use of the DTCP technology between the IEEE 1394 apparatus connected to the IEEE 1394 bus and the device that communicates with the Blue tooth.

In order to accomplish this objective, when the copyright information is transferred from the IEEE 1394 apparatus 5 connected to the IEEE 1394 cable 6 to a device 40 that communicates with the Blue tooth as shown in FIG. 14, in a format conversion adapter 38, the IEEE 1394 packet transferred from the IEEE 1394 apparatus 5 is inserted into the data section of the data packet that is possible to transfer with the Blue tooth. Also, the format conversion adapter 38 inserts into this data packet the [Destination ID] that is the identifier of the device.

Also, when the data is transferred from the device 40 that communicates with the Blue tooth to the IEEE 1394 apparatus 5 connected to the IEEE 1394 cable 6, in a device 40, the data that is inserted into the data region of the data packet is generated in the IEEE 1394 packet format. Also, into this data packet is built the identifier [Destination ID] for identifying the apparatus of a transmitting destination. The data formed in such a format is transferred to the format conversion adapter 38, wherein the data generated in the IEEE 1394 format is fetched from the data region of the data packet and is transferred to the IEEE 1394 apparatus 5 side.

In such a manner, the DTCP becomes possible to apply between the IEEE 1394 apparatus connected to the IEEE 1394 bus and the device that communicates with the Blue tooth, and the dishonest copy of information being transmitted and received between the IEEE 1394 apparatus and the Blue tooth correspondence communication device can be prevented.

Also, in order to transmit and receive the copyright information between the IEEE 1394 apparatus connected to the IEEE 1394 bus and the Blue tooth correspondence communication device, the existing DTCP specified by the IEEE 1394 was caused to be applicable in the Blue tooth side as well, thereby, an application of the dishonest copy preventive technology that differs bus by bus can be dispensed with, and an expenditure of a system architecture for transmitting and receiving the copyright information can be reduced.

Next, the sixteenth embodiment relating to the present invention will be explained. The sixteenth embodiment relating to the present invention is characterized by newly defining for the packet of the Blue tooth the dishonest copy protection bit indicating the CCI and the change timing of the key, and the [Destination ID] defined in the embodiments set forth above. This allows the dishonest copy protection technology of the IEEE 1394 to be applied in the data packet of the Blue tooth as well.

Next, the seventeenth embodiment relating to the present invention will be explained. The seventeenth embodiment relating to the present invention is characterized in that all packet formats of the USB, the PCI, the PCMCIA, the IrDA, the SCSI, the C bus and the Blue tooth were caused to be identical to the packet format of the IEEE 1394 in order that the DTCP is applied between the IEEE 1394 apparatus over the IEEE 1394 bus and the apparatus connected to the different buses and interfaces (USB, PCI, PCMCIA, IrDA, SCSI, C bus and Blue tooth) from this IEEE 1394 bus, and that the copyright information can be transmitted and received. The packet format of the IEEE 1394 is the same as what has already been explained in details in the foregoing first embodiment. Accordingly, a new definition is obviated of the bit indicating the CCI, the bit indicating the change timing of the key and the like that are at stake when the DTCP is applied.

In addition, the embodiments set forth above are the preferred embodiments of the present invention. However, the present invention is not limited hereto, and various embodiments can be applied without departing from the spirit of the present invention. For example, the technology can be carried out for providing the dishonest copy preventive technology set forth above to the other bus as long as the bus is one with a serial interface specification such as RS-232C and so forth.

As apparent from the foregoing description, in the present invention, when the data is transmitted from the IEEE 1394 apparatus connected to the IEEE 1394 bus to the communication device connected to the other bus than the IEEE 1394 bus, into the packet with the form that corresponded to the other bus than the IEEE 1394 bus are inserted the packet with the IEEE 1394 form transferred from the IEEE 1394 apparatus and identification information for identifying the communication device, which was defined on each communication device, to transfer it to the communication side, and when the data is transferred from the communication device to the IEEE 1394 apparatus, the packet with the IEEE 1394 form is fetched from the packet that corresponded to the other bus than the IEEE 1394 bus into which were inserted the packet with the IEEE 1394 form and the identification information, which are generated in the communication device, to transfer it to the IEEE 1394 apparatus side, thereby, the dishonest copy preventive technology of the IEEE 1394 becomes possible to use in the other bus than the IEEE 1394 bus, and the copyright information can be transmitted and received between the IEEE 1394 apparatus and the communication device.

Furthermore, in order to transmit and receive the copyright information between the IEEE 1394 apparatus connected to the IEEE 1394 bus and the communication device connected to the other bus than the IEEE 1394 bus, the existing dishonest copy preventive technology specified by the IEEE 1394 was caused to be applicable, thereby an application of the dishonest copy preventive technology that differs bus by bus can be dispensed with, and an expenditure of a system architecture for transmitting and receiving the copyright information can be reduced.

Also, when the data is transmitted from the IEEE 1394 apparatus connected to the IEEE 1394 bus to the radio device that communicates with radio, into the packet with the form that corresponded to the radio communication are inserted the packet with the IEEE 1394 form transferred from the IEEE 1394 apparatus and identification information for identifying the radio device, which was defined on each radio device, to transfer it to the radio device side, and when the data is transferred from the radio device to the IEEE 1394 apparatus, the packet with the IEEE 1394 form is fetched from the packet with the form that corresponded to the radio communication into which were inserted the packet with the IEEE 1394 form and the identification information, which are generated by the radio device, to transfer it to the IEEE 1394 apparatus side, thereby, the dishonest copy preventive technology of the IEEE 1394 becomes possible to apply in the radio communication, and the copyright information can be transmitted and received between the IEEE 1394 apparatus and the radio device.

Furthermore, in order to transmit and receive the copyright information between the IEEE 1394 apparatus connected to the IEEE 1394 bus and the radio device that communicates with radio, the existing dishonest copy preventive technology specified by the IEEE 1394 was caused to be applicable, thereby, an application of the dishonest copy preventive technology that differs interface by interface can be dispensed with, and an expenditure of a system architecture for transmitting and receiving copyright information can be reduced.

Also, in the radio device connected to the other bus than the IEEE 1394 bus, which transmits/receives data to/from the IEEE 1394 apparatus that corresponded to the IEEE 1394 bus, the packet is prepared that includes: information of a copy control that set an allowable number of copy of the transfer data; information indicating the change timing of the cryptograph key that is used for encrypting the data to transmit and receive; and identification information for identifying the radio device connected to the other bus than the IEEE 1394 bus, which was defined on each radio device, to transfer it to the IEEE 1394 apparatus, thereby, the dishonest copy preventive technology of the IEEE 1394 becomes possible to use in the other bus than the IEEE 1394 bus, and the copyright information can be transmitted and received between the IEEE 1394 apparatus and the radio device.

Furthermore, in order to transmit and receive the copyright information between the IEEE 1394 apparatus connected to the IEEE 1394 bus and the radio device connected to the other bus than the IEEE 1394 bus, the existing dishonest copy preventive technology specified by the IEEE 1394 was caused to be applicable, thereby, an application of the dishonest copy preventive technology that differs interface by interface can be dispensed with, and an expenditure of a system architecture for transmitting and receiving copyright information can be reduced.

Also, in the communication device connected to the other bus than the IEEE 1394 bus, which transmits/receives data to/from the IEEE 1394 apparatus connected to the IEEE 1394 bus, when the data is transferred to the IEEE 1394 apparatus, a preparation of the packet in the packet format of the IEEE 1394 allows the dishonest copy preventive technology of the IEEE 1394 to be used in the other bus than the IEEE 1394 bus, thus enabling transmission and reception of copyright information between the IEEE 1394 apparatus and the radio device.

Furthermore, in order to transmit and receive the copyright information between the IEEE 1394 apparatus connected to the IEEE 1394 bus and the communication device connected to the other bus than the IEEE 1394 bus, the existing dishonest copy preventive technology specified by the IEEE 1394 was caused to be applicable, thereby, an application of the dishonest copy preventive technology that differs interface by interface can be dispensed with, and an expenditure of a system architecture for transmitting and receiving copyright information can be reduced.

Also, in the radio device that transmits/receives data with radio to/from the IEEE 1394 apparatus connected to the IEEE 1394 bus, by preparing the packet that includes: information of a copy control that set an allowable number of copy of the transfer data; information indicating the change timing of the cryptograph key that is used for encrypting the data to transmit and receive the encrypted data; and identification information for identifying the device, which was defined on each device, to transfer it to the IEEE 1394 apparatus, the dishonest copy preventive technology of the IEEE 1394 becomes possible to apply in the radio communication, and the copyright information can be transmitted and received between the IEEE 1394 apparatus and the radio device.

Furthermore, in order to transmit and receive the copyright information between the IEEE 1394 apparatus connected to the IEEE 1394 bus and the radio device that communicates with radio, the existing dishonest copy preventive technology specified by the IEEE 1394 was caused to be applicable, thereby, an application of the dishonest copy preventive technology that differs interface by interface can be dispensed with, and an expenditure of a system architecture for transmitting and receiving copyright information can be reduced.

Also, in the radio device that transmits/receives data with radio to/from the IEEE 1394 apparatus connected to the IEEE 1394 bus, when the data is transferred to the IEEE 1394 apparatus, a preparation of the packet in the packet format of the IEEE 1394 allows the dishonest copy preventive technology of the IEEE 1394 to be applied in the radio communication, and the copyright information can be transmitted and received between the IEEE 1394 apparatus and the radio device.

Furthermore, in order to transmit and receive the copyright information between the IEEE 1394 apparatus connected to the IEEE 1394 bus and the radio device that communicates with radio, the existing dishonest copy preventive technology specified by the IEEE 1394 was caused to be applicable, thereby, an application of the dishonest copy preventive technology that differs interface by interface can be dispensed with, and an expenditure of a system architecture for transmitting and receiving copyright information can be reduced.

The entire disclosure of Japanese Patent No.2000-155959 filed on May 23, 2000 including specification, claims, drawing and summary are incorporated herein by reference in its entirety.

What is claimed is:

1. A system of a data transfer between an apparatus that corresponded to IEEE 1394, which was connected to a bus that corresponded to said IEEE 1394, and a communication device connected to said other bus than said bus that corresponded to said IEEE 1394, comprising packet form conversion means of:
inserting within a packet with a form that corresponded to said other bus than said bus that corresponded to said IEEE 1394, a packet with said IEEE 1394 form transferred from said apparatus that corresponded to said IEEE 1394, and identification information for identifying said corresponding communication device, which was defined on each communication device, to transfer it to said communication device side; and
fetching said packet with said IEEE 1394 form from said packet that corresponded to said other bus than said bus that corresponded to said IEEE 1394 into which were inserted said packet with said IEEE 1394 form and said identification information, which are generated by said communication device, to transfer it to said apparatus side that corresponded to said IEEE 1394.

2. The data transfer system according to claim 1, wherein said other bus than said bus that corresponded to said IEEE 1394 is a serial bus.

3. The data transfer system according to claim 1, wherein said other bus than said bus that corresponded to said IEEE 1394 is anyone of a PCI bus, a PCMCIA bus, a SCSI bus, an ISA bus and a C bus.

4. A system of a data transfer between an apparatus that corresponded to IEEE 1394, which was connected to a bus that corresponded to IEEE 1394, and a radio device that communicates with radio, comprising packet form conversion means of:
inserting within a packet with a form that corresponded to said radio communication, a packet with said IEEE 1394 form transferred from said apparatus that corresponded to said IEEE 1394, and identification information for identifying said corresponding radio device, which was defined on each said radio device, to transfer it to said radio device side; and
fetching said packet with said IEEE 1394 form from said packet with said form that corresponded to said radio communication into which were inserted said packet with said IEEE 1394 form and said identification information, which are generated by said radio device, to transfer it to said apparatus side that corresponded to said IEEE 1394.

5. The data transfer system according to claim 4, wherein said communication with radio is a communication with a communication technology based on anyone of an IrDA and a Blue tooth.

6. A communication device connected to other bus than a bus that corresponded to IEEE 1394, which transmits/receives data to/from an apparatus that corresponded to said IEEE 1394, which was connected to said bus that corresponded to said IEEE 1394, said communication device including means of preparing a packet that includes:
information of a copy control that set an allowable number of copy of transfer data;
information indicating a change timing of a cryptograph key that is used for encrypting said data to transmit and receive; and identification information for identifying said corresponding communication device, which was defined on each communication device connected to said other bus than said bus that corresponded to said IEEE 1394, to transfer said data to said apparatus that corresponded to said IEEE 1394.

7. The communication device according to claim 6, wherein said other bus than said bus that corresponded to said IEEE 1394 is a serial bus.

8. The communication device according to claim 6, wherein said other bus than said bus that corresponded to said IEEE 1394 is anyone of a PCI bus, a PCMCIA bus, a SCSI bus, an ISA bus and a C bus.

9. A communication device connected to other bus than a bus that corresponded to IEEE 1394, which transmits/receives data to/from an apparatus that corresponded to a specification of said IEEE 1394, which was connected to said bus that corresponded to said IEEE 1394 said communication device including means for preparing a packet in a packet format of said IEEE 1394, when said data is transferred to said apparatus that corresponded to said IEEE 1394.

10. The communication device according to claim 9, wherein said other bus than said bus that corresponded to said IEEE 1394 is a serial bus.

11. The communication device according to claim 9, wherein said other bus than said bus that corresponded to said IEEE 1394 is anyone of a PCI bus, a PCMCIA bus, a SCSI bus, an ISA bus and a C bus.

12. A radio device that transmits/receives data to/from an apparatus that corresponded to a specification of IEEE 1394, which was connected to a bus that corresponded to said IEEE 1394, said radio device including means of preparing a packet that includes:
information of a copy control that set an allowable number of copy of transfer data;
information indicating a change timing of a cryptograph key that is used for encrypting said data to transmit and receive; and
identification information for identifying said corresponding radio device, which was defined on each said radio device, to transfer said data to said apparatus that corresponded to said IEEE 1394.

13. The radio device according to claim 12, wherein said communication with radio is a communication with a communication technology based on anyone of an IrDA and a Blue tooth.

14. A radio device that transmits/receives data to/from an apparatus that corresponded to IEEE 1394, which was connected to a bus that corresponded to said IEEE 1394, said radio device including means for preparing a packet in a packet format of said IEEE 1394, when said data is transferred to said apparatus that corresponded to said IEEE 1394.

15. The radio device according to claim 14, wherein said communication with radio is a communication with a communication technology based on anyone of an IrDA and a Blue tooth.

16. A dishonest copy preventive method in a data transfer system that transfers data between an apparatus that corresponded to IEEE 1394, which was connected to a bus that corresponded to said IEEE 1394, and a communication device connected to other bus than a bus that corresponded to said IEEE 1394, comprising:
a first packet form conversion step of inserting within a packet with a form that corresponded to said other bus than said IEEE 1394 bus, a packet with said IEEE 1394 form transferred from said apparatus that corresponded to said IEEE 1394 and identification information for identifying said corresponding communication device, which was defined on each communication device, to transfer it to said communication device; and
a second packet form conversion step of fetching said packet with said IEEE 1394 form from said packet that corresponded to said other bus than said bus that corresponded to said IEEE 1394 into which were inserted said packet with said IEEE 1394 form and said identification information, which are generated by said communication device, to transfer it to said apparatus side that corresponded to said IEEE 1394.

17. The dishonest copy preventive method in a data transfer system according to claim 16, wherein said other bus than said bus that corresponded to said IEEE 1394 is a serial bus.

18. The dishonest copy preventive method in a data transfer system according to claim 16, wherein said other bus than said bus that corresponded to said IEEE 1394 is anyone of a PCI bus, a PCMCIA bus, a SCSI bus, an ISA bus and a C bus.

19. A dishonest copy preventive method in a data transfer system that transfers data between an apparatus that corresponded to IEEE 1394, which was connected to a bus that corresponded to said IEEE 1394, and a radio device that communicates with radio,
said dishonest copy preventive method in a data transfer system comprising:
a first packet form conversion step of inserting within a packet with a form that corresponded to said radio communication, a packet with said IEEE 1394 form transferred from said apparatus that corresponded to said IEEE 1394, and identification information for identifying said corresponding radio device, which was defined on each said radio device, to transfer it to said radio device side; and
a second packet form conversion step of fetching said packet with said IEEE 1394 form from said packet that corresponded to said radio communication into which were inserted said packet with said IEEE 1394 format and said identification information, which are generated by said communication device, to transfer it to said apparatus side that corresponded to said IEEE 1394.

20. The dishonest copy preventive method in a data transfer system according to claim 19, wherein said communication with radio is a communication with a communication technology based on anyone of an IrDA and a Blue tooth.

21. A dishonest copy preventive method in a communication device connected to other bus than a
bus that corresponded to IEEE 1394, which transmits/receives data to/from an IEEE 1394 apparatus connected to a bus that corresponded to said IEEE 1394, comprising the steps of:
preparing a packet that includes information of a copy control that set an allowable number of copy of transfer data, information indicating a change timing of a cryptograph key that is used for encrypting said data to transmit and receive, and identification information for identifying said corresponding communication device, which was defined on each communication device connected to said other bus than said bus that corresponded to said IEEE 1394; and transferring said packet to said apparatus that corresponded to said IEEE 1394.

22. The dishonest copy preventive method in a communication device according to claim 21, wherein said other bus than said bus that corresponded to said IEEE 1394 is a serial bus.

23. The dishonest copy preventive method in a communication device according to claim 21, wherein said other bus than said bus that corresponded to said IEEE 1394 is anyone of a PCI bus, a PCMCIA bus, a SCSI bus, an ISA bus and a C bus.

24. A dishonest copy preventive method in a communication device connected to other bus than a bus that corresponded to IEEE 1394, which transmits/receives data to/from an apparatus that corresponded to said IEEE 1394, which was connected to a bus that corresponded to said IEEE 1394, comprising a step of preparing a packet in a packet format of said IEEE 1394, when said data is transferred to said apparatus that corresponded to said IEEE 1394.

25. The dishonest copy preventive method in a communication device according to claim 24, wherein said other bus than said bus that corresponded to said IEEE 1394 is a serial bus.

26. The dishonest copy preventive method in a communication device according to claim 24, wherein said other bus than said bus that corresponded to said IEEE 1394 is anyone of a PCI bus, a PCMCIA bus, a SCSI bus, an ISA bus and a C bus.

27. A dishonest copy preventive method in a radio device that transmits/receives data with radio to/from an apparatus that corresponded to IEEE 1394, which was connected to a bus that corresponded to said IEEE 1394, comprising the steps of:
preparing a packet that includes information of a copy control that set an allowable number of copy of transfer data, information indicating a change timing of a cryptograph key that is used for encrypting said data to transmit and receive, and identification information for identifying said corresponding radio device, which was defined on each said radio device; and
transferring said packet to said apparatus that corresponded to said IEEE 1394.

28. The dishonest copy preventive method in a radio device according to claim 27, wherein said communication with radio is a communication with a communication technology based on anyone of an IrDA and a Blue tooth.

29. A dishonest copy preventive method in a radio device that transmits/receives data with radio to/from an apparatus that corresponded to IEEE 1394, which was connected to a bus that corresponded to said IEEE 1394, comprising:
a step of preparing a packet in a packet format of said IEEE 1394, when said data is transferred to said apparatus that corresponded to said IEEE 1394.

30. The dishonest copy preventive method in a radio device according to claim 29, wherein said communication with radio is a communication with a communication technology based on anyone of an IrDA and a Blue tooth.

31. A record medium having recorded a dishonest copy preventive program in a data transfer system that transfers data between an apparatus that corresponded to said IEEE 1394, which was connected to a bus that corresponded to said IEEE 1394, and a communication device connected to other bus than a bus that corresponded to said IEEE 1394, said record medium having recorded said dishonest copy preventive program of said data transfer system for executing:
a first packet form conversion process of inserting within a packet with a form that corresponded to said other bus than said bus that corresponded to said IEEE 1394, a packet with said IEEE 1394 form transferred from said apparatus that corresponded to said IEEE 1394, and identification information for identifying said corresponding communication device, which was defined on each communication device, to transfer it to said communication device side; and
a second packet form conversion process of fetching said packet with said IEEE 1394 form from said packet that corresponded to said other bus than said bus that corresponded to said IEEE 1394 into which were inserted said packet with said IEEE 1394 form and identification information, which are generated by said communication device, to transfer it to said apparatus side that corresponded to said IEEE 1394.

32. The record medium having recorded a dishonest copy preventive program of a data transfer system according to claim 31, wherein said other bus than said bus that corresponded to said IEEE 1394 is a serial bus.

33. The record medium having recorded a dishonest copy preventive program of a data transfer system according to claim 31, wherein said other bus than said bus that corresponded to said IEEE 1394 is anyone of a PCI bus, a PCMCIA bus, a SCSI bus, an ISA bus and a C bus.

34. A record medium having recorded a dishonest copy preventive program in a data transfer system that transfers data between an apparatus that corresponded to IEEE 1394, which was connected to a bus that corresponded to said IEEE 1394, and a radio device that communicates with radio, said record medium having recorded said dishonest preventive program of said data transfer system for executing:
a first packet form conversion process of inserting within a packet with a form that corresponded to said radio communication, a packet with said IEEE 1394 form transferred from said apparatus that corresponded to said IEEE 1394 and identification information for identifying said corresponding communication device, which was defined on each said radio device, to transfer it to said radio device side; and
a second packet form conversion process of fetching said packet with said IEEE 1394 form from said packet with said form that corresponded to said radio communication into which were inserted said packet with said IEEE 1394 form and said identification information, which are generated by said radio device, to transfer it to said apparatus side that corresponded to said IEEE 1394.

35. The record medium having recorded a dishonest copy preventive program of a data transfer system according to claim 34, wherein said communication with radio is communication with a communication technology based on anyone of an IrDA and a Blue tooth.

36. A record medium having recorded a dishonest copy preventive program in a communication device connected to other bus than a bus that corresponded to IEEE 1394, which transmits/receives data to/from an apparatus that corresponded to said IEEE 1394, which was connected to a bus that corresponded to said IEEE 1394, said record medium having recorded said dishonest copy preventive program of said communication device for preparing a packet that includes:
information of a copy control that set an allowable number of copy of transfer data;
information indicating a change timing of a cryptograph key that is used for encrypting said data to transmit and receive; and
identification information for identifying said communication device, which was defined on each communication device connected to said other bus than said bus that corresponded to said IEEE 1394, to execute said data transfer to said apparatus that corresponded to said IEEE 1394.

37. The record medium having recorded a dishonest copy preventive program in a communication device according to claim 36, wherein said other bus than said bus that corresponded to said IEEE 1394 is a serial bus.

38. The record medium having recorded a dishonest copy preventive program in a communication device according to claim 36, wherein said other bus than said bus that corresponded to said IEEE 1394 is anyone of a PCI bus, a PCMCIA bus, a SCSI bus, an ISA bus and a C bus.

39. A record medium having recorded a dishonest copy preventive program in a communication device connected to other bus than a bus that corresponded to IEEE 1394, which transmits/receives data to/from an apparatus that corresponded to said IEEE 1394, which was connected to a bus that corresponded to said IEEE 1394,
said record medium having recorded said dishonest copy preventive program of said communication device for preparing a packet in a packet format of said IEEE 1394 to execute a data transfer to said apparatus that corresponded to said IEEE 1394, when said data is transferred to said apparatus that corresponded to said IEEE 1394.

40. The record medium having recorded a dishonest copy preventive program of a communication device according to claim 39, wherein said other than said IEEE 1394 bus is a serial bus.

41. The record medium having recorded a dishonest copy preventive program of a communication device according to claim 39, wherein said other bus than said bus that corresponded to said IEEE 1394 is anyone of a PCI bus, a PCMCIA bus, a SCSI bus, an ISA bus and a C bus.

42. A record medium having recorded a dishonest copy preventive program in a radio device that transmits/receives data to/from an apparatus that corresponded to IEEE 1394, which was connected to a bus that corresponded to said IEEE 1394, said record medium having recorded said dishonest copy preventive program of said radio device for preparing a packet that includes: information of a copy control that set an allowable number of copy of transfer data;
information indicating a change timing of a cryptograph key that is used for encrypting said data to transmit and receive; and
identification information for identifying said corresponding radio device, which was defined on each said radio device, to execute said data transfer to said apparatus that corresponded to said IEEE 1394.

43. The record medium having recorded a dishonest copy preventive program of a radio device according to claim 42, wherein said communication with radio is a communication with a communication technology based on anyone of an IrDA and a Blue tooth.

44. A record medium having recorded a dishonest copy preventive program in a radio device that transmits/receives data with radio to/from an apparatus that corresponded to IEEE 1394, which was connected to a bus that corresponded to said IEEE 1394,
said record medium having recorded a program for preparing a packet in a packet format of said IEEE 1394 to execute a data transfer to said apparatus that corresponded to said IEEE 1394, when said data is transferred to said apparatus that corresponded to said IEEE 1394.

45. The record medium having recorded a dishonest copy preventive program of a radio device according to claim 44, wherein said communication with radio is a communication with a communication technology based on anyone of an IrDA and a Blue tooth.
